(19) United States
(12) Patent Application Publication
(10) Pub. No.: US 2010/0137643 A1
(43) Pub. Date: Jun. 3, 2010

(54) METHOD FOR SYNTHESIZING CYCLOHEXYL-SUBSTITUTED PHOSPHINES

(75) Inventors: Alexander Tishkov, Mannheim (DE); Klemens Massonne, Bad Duerkheim (DE); Daniela Mirk, Hassloch (DE); Jochem Henkelmann, Mannheim (DE); Matthias Maase, New Jersey, NJ (US); Thomas Wettling, Limburgerhof (DE)

Correspondence Address: OBLON, SPIVAK, MCCLELLAND MAIER & NEUSTADT, L.L.P., 1940 DUKE STREET, ALEXANDRIA, VA, 22314, US

(73) Assignee: Basf SE, Ludwigshafen (DE)

(21) Appl. No.: 12/598,934

(22) PCT Filed: May 7, 2008
(86) PCT No.: PCT/EP08/55655

§ 371 Date: Nov. 5, 2009

(30) Foreign Application Priority Data
May 8, 2007 (EP) 07107753.1

(51) Int. Cl. C07F 9/02

(52) U.S. Cl. 568/14; 568/16

(57) ABSTRACT

The present invention relates to a process for preparing cyclohexyl-substituted phosphines. The invention further relates to a process for preparing cyclohexyl-substituted phosphine oxides which can be used as intermediates in the preparation of cyclohexyl-substituted phosphines.

The present invention relates to a process for preparing cyclohexyl-substituted phosphines. The invention further relates to a process for preparing cyclohexyl-substituted phosphine oxides which can be used as intermediates in the preparation of cyclohexyl-substituted phosphines.

Cyclohexyl-substituted phosphines, such as tricyclohexylphosphine, ring-hydrogenated DIOP or ring-hydrogenated chiraphos, are important ligands which are used in numerous reactions, for example in metathesis reactions, carbonylation reactions and Suzuki couplings.

To date, cyclohexyl-substituted phosphines have been prepared generally from the cyclohexyl and phosphine base units or by ring hydrogenation of the corresponding phenyl-substituted phosphines.

For example, tricyclohexylphosphine is prepared predominantly by reacting phosphorus trichloride with a cyclohexylmagnesium halide, as described, for example, in Z. Anorg. Allg. Chem. 277, 1954, 258 or in Chem. Ber. 95, 1962, 1894. Disadvantages here are the handling of the reactants, which is not unproblematic, as is the case for all magnesium organyls, the purification of the end product and the unsatisfactory yields.

A further means of preparing tricyclohexylphosphine is the hydrogenation of triphenylphosphine. The customary hydrogenation catalysts are, however, unsuitable for this purpose, since they are complexed by the phosphorus atom and hence deactivated. Only a few niobium and tantalum catalysts are suitable (J. Chem. Soc., Chem. Commun. 1992, 8, 632, J. Chem. Soc., Chem. Commun. 1995, 8, 849, WO 93/321192). However, they are not only very expensive but are also destroyed during the reaction.

It was therefore an object of the present invention to provide a process which overcomes the above-described disadvantages. In particular, it should be employable on the industrial scale, not entail any complicated process steps and proceed from inexpensive, readily available reactants.

The object is achieved by a process for preparing compounds of the formula I

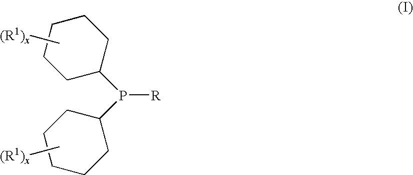

in which

R is a radical of the formula II

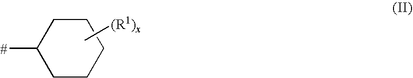

or a linear or branched alkyl radical which has from 1 to 8 carbon atoms and bears 1, 2, 3 or 4 radicals of the formula III

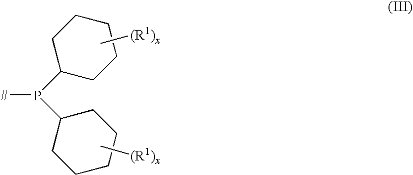

and may also bear from 1 to 4 substituents of the formula IV

X—(CH₂)ₐ_{b}—YR⁷ (IV)
X and Y are each independently O or NR^{B};
each R¹ is independently C₁-C₄-alkyl, C₁-C₄-haloalkyl, C₁-C₄-hydroxyalkyl, C₃-C₁₀-cycloalkyl, C₃-C₁₀-halocycloalkyl, halogen, OR² or COR^{S};
R² is H or C₁-C₄-alkyl;
R³ is H, C₁-C₄-alkyl, OR⁴ or NR⁵R⁶;
R⁴, R⁵ and R⁶ are each independently H or C₁-C₄-alkyl;
R⁷ is H, C₁-C₄-alkyl or C₂-C₄-hydroxyalkyl;
   or, in the case that two substituents of the formula IV are bonded to the same carbon atom or to two adjacent carbon atoms of the alkyl radical, two R⁷ radicals may also together form a linear or branched alkylene group having from 1 to 6 carbon atoms;
R⁸ is H, C₁-C₄-alkyl or C₂-C₄-hydroxyalkyl;
each x is independently 0, 1, 2 or 3;
a is 2, 3 or 4;
b is 0, 1, 2, 3 k, 4, 5, 6, 7, 8, 9 or 10; and
# denotes the point of attachment to the rest of the molecule;
   or hydrohalides thereof, comprising the following step:
   reacting compounds of the formula V

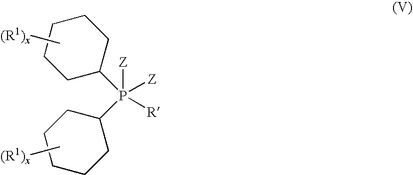

in which
R′ is a radical of the formula II or a linear or branched alkyl radical which has from 1 to 8 carbon atoms and bears 1, 2, 3 or 4 radicals of the formula VI

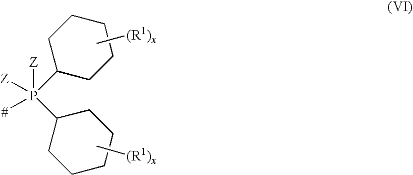

and may also bear from 1 to 4 substituents of the formula IV;
Z is halogen; and
R¹, x and # are each as defined above;
with hydrogen at a pressure of from 10 to 300 bar.

This process is referred to hereinafter as process A.

The formulae V and VI shall not be interpreted in a restrictive manner with regards to the actual electronic structure of the phosphine dihalide group. In particular, it shall not be interpreted to the effect that the halogen atoms are bonded covalently to the phosphorus atom, since it is also possible for ionic bonds to be present (for example in the form of [PX]⁺X⁻). They should be understood such that two cyclohexyl radicals and the R′ radical or the alkyl radical are bonded to the phosphorus atom covalently, and two halogen atoms via a bonding form not specified in detail (which may, for example, be covalent or ionic and may be the same or different for the two halogen atoms).

In the context of the present invention, the generic expressions have the following meanings:

Halogen is fluorine, chlorine, bromine or iodine, preferably fluorine, chlorine or bromine and especially chlorine or bromine.

C₁-C₄-Alkyl is a linear or branched alkyl radical having from 1 to 4 carbon atoms. Examples thereof are methyl, ethyl, propyl, isopropyl, n-butyl, sec-butyl, isobutyl and tert-butyl.

C₁-C₆-Alkyl is a linear or branched alkyl radical having from 1 to 6 carbon atoms. Examples thereof are methyl, ethyl, propyl, isopropyl, n-butyl, sec-butyl, isobutyl, tert-butyl, pentyl, isopentyl, neopentyl, 2,2-dimethylpropyl, hexyl, isohexyl and positional isomers thereof.

C₁-C₈-Alkyl (“alkyl radical having from 1 to 8 carbon atoms”) is a linear or branched alkyl radical having from 1 to 8 carbon atoms. Examples thereof are, as well as the examples already cited for C₁-C₄-alkyl, heptyl, 3,3-dimethylpentyl, octyl and 2-ethyl-hexyl, and positional isomers thereof.

C₁-C₁₀-Alkyl is a linear or branched alkyl radical having from 1 to 10 carbon atoms. Examples thereof, as well as the examples already cited for C₁-C₆-alkyl, are heptyl, octyl, 2-ethylhexyl, nonyl, decyl and 2-propylheptyl, and positional isomers thereof.

When the alkyl radical is substituted and bears, for example, 1, 2, 3 or 4 radicals of the formulae III, VI, VIII or XI, it is obvious that the corresponding number of hydrogen atoms in the above-defined alkyl radicals is replaced by these substituents.

C₁-C₄-Hydroxyalkyl is a linear or branched alkyl radical having from 1 to 4 carbon atoms, in which one or more hydrogen atoms may be replaced by a hydroxyl group, where each carbon atom generally bears at most one hydroxyl group. Examples thereof are hydroxymethyl, 2-hydroxyethyl, 2- and 3-hydroxypropyl, 2,3-dihydroxy-propyl, 4-hydroxybutyl and the like.

C₂-C₄-Hydroxyalkyl is a linear or branched alkyl radical having from 2 to 4 carbon atoms, in which one or more hydrogen atoms are replaced by a hydroxyl group, where each carbon atom generally bears at most one hydroxyl group and where the hydroxyl group(s) is/are generally not bonded on the carbon atom in the 1-position of the alkyl group. Examples thereof are 2-hydroxyethyl, 2- and 3-hydroxypropyl, 2,3-dihydroxy-propyl, 4-hydroxybutyl and the like.

C₁-C₆-Hydroxyalkyl is a linear or branched alkyl radical having from 1 to 6 carbon atoms, in which one or more hydrogen atoms are replaced by a hydroxyl group, where each carbon atom generally bears at most one hydroxyl group. Examples thereof, as well as the examples cited for C₁-C₄-hydroxyalkyl, are pentaerythritol and sorbitol.

C₁-C₁₀-Hydroxyalkyl is a linear or branched alkyl radical having from 1 to 10 carbon atoms, in which one or more hydrogen atoms are replaced by a hydroxyl group, where each carbon atom generally bears at most one hydroxyl group. Examples thereof are hydroxymethyl, 2-hydroxyethyl, 2- and 3-hydroxypropyl, 2,3-dihydroxypropyl, 4-hydroxybutyl, pentaerythritol, sorbitol and the like.

C₁-C₄-Haloalkyl is a linear or branched alkyl radical having from 1 to 4 carbon atoms, in which one or more hydrogen atoms are replaced by a halogen atom. Examples thereof are chloromethyl, dichloromethyl, trichloromethyl, fluoromethyl, difluoromethyl, trifluoromethyl, chloroethyl, 2,2- and 1,2-dichloroethyl, 1,1,2-, 1,2,2- and 2,2,2-trichloroethyl, pentachloroethyl, fluoroethyl, 2,2- and 1,2-difluoroethyl, 1,1,2-, 1,2,2- and 2,2,2-trifluoroethyl, pentafluoroethyl, chloropropyl, dichloropropyl, trichloropropyl, pentachloropropyl, heptachloropropyl, fluoropropyl, difluoropropyl, trifluoropropyl, pentafluoropropyl, heptafluoropropyl, chlorobutyl, dichlorobutyl, trichlorobutyl, fluorobutyl, difluorobutyl, trifluorobutyl and the like.

C₃-C₁₀-Cycloalkyl is an optionally substituted mono- or polycyclic cycloalkyl group having from 3 to 10 carbon atoms as ring members. Examples of monocyclic groups are cyclopropyl, cyclobutyl, cyclopentyl, cyclohexyl, cycloheptyl, cyclooctyl, cyclononyl and cyclodecyl. Examples of polycyclic groups are norbornyl, decalinyl, adamantyl and the like. Suitable substituents are, for example, C₁-C₆-alkyl, C₁-C₆-alkoxy and halogen.

C₃-C₁₀-Halocycloalkyl is an optionally substituted mono- or polycyclic cycloalkyl group having from 3 to 10 carbon atoms as ring members, in which one or more hydrogen atoms are replaced by a halogen atom. Examples thereof are chlorocyclopropyl, dichlorocyclopropyl, fluorocyclopropyl, difluorocyclopropyl, chlorocyclopentyl, dichlorocyclopentyl, fluorocyclopentyl, difluorocyclopentyl and the like.

In the context of the present invention, aryl is an aromatic hydrocarbon radical having from 6 to 14 carbon atoms, such as phenyl, naphthyl, anthracenyl or phenanthrenyl. The aryl radical may be unsubstituted or bear from 1 to 4 substituents. Suitable substituents are, for example, C₁-C₆-alkyl, C₁-C₆-haloalkyl, C₁-C₆-alkoxy, halogen, nitro, CN, COOR^{d}, COR^{e}, SO₂OR^{f}, SO₂R^{g}, SR^{h} and NRⁱR^{j}, where R^{d}, R^{e}, R^{f}, R^{g} and R^{h} are each independently H or C₁-C₆-alkyl, and where Rⁱ and R^{j} are each H, C₁-C₆-alkyl or C₂-C₆-hydroxyalkyl. Examples thereof are phenyl, naphthyl, chlorophenyl, methylphenyl, ethylphenyl, propylphenyl, isopropylphenyl, 1-butylphenyl, 2-butylphenyl, isobutylphenyl, tert-butylphenyl, nitrophenyl, carboxyphenyl, formylphenyl, acetylphenyl, sulfonylphenyl, methylsulfonylphenyl, sulfonylnaphthyl, methylsulfonyl-naphthyl, carboxynaphthyl and the like.

Aryl-C₁-C₄-alkyl is a C₁-C₄-alkyl radical which is substituted by an aryl group. Examples thereof are benzyl and 1- and 2-phenylethyl.

Alkylene is a difunctional aliphatic saturated linear or branched radical having, for example, from 1 to 8 or from 1 to 6 carbon atoms. Examples thereof are methylene (—CH₂—), 1,1-ethylene (—CH(CH₃)—), 1,2-ethylene (—CH₂CH₂—), 1,1-propylene (—CH(CH₂CH₃)—), 2,2-propylene (—C(CH₃)₂—), 1,2-propylene (—CH₂—CH(CH₃)—), 1,3-propylene (—CH₂CH₂CH₂—), 1,1-butylene (—CH(CH₂CH₂CH₃)—), 2,2-butylene (—C(CH₃)(CH₂CH₃)—), 1,2-butylene (—CH₂—CH(CH₂CH₃)—), 2,3-butylene (—CH(CH₃)—CH(CH₃)—), 1,4-butylene (—CH₂CH₂CH₂CH₂—), 1,3-pentylene (CH(CH₃)—CH₂—CH(CH₃)—), 2,2-dimethyl-1,3-propylene (—CH₂—C(CH₃)₂—CH₂—), 1,5-pentylene (—(CH₂)₆—) and the like.

The remarks made below regarding preferred embodiments of the processes according to the invention, of the reactants used and of the products obtained apply either taken alone or preferably in combination with one another.

In process A, the compound V is reduced with hydrogen preferably without the use of a transition metal catalyst. In particular, the reduction is effected without the use of catalysts.

Z is preferably Cl, i.e. the reactant V to be reduced is preferably a phosphine dichloride.

In process A, the pressure is preferably at least 30 bar, for example from 30 to 300 bar, preferably from 30 to 250 bar, more preferably from 30 to 200 bar and especially from 30 to 150 bar; more preferably at least 50 bar, for example from 50 to 300 bar, preferably from 50 to 250 bar, more preferably from 50 to 200 bar and especially from 50 to 150 bar; more preferably at least 80 bar, for example from 80 to 300 bar, preferably from 80 to 250 bar, more preferably from 80 to 200 bar and especially from 80 to 150 bar; and especially at least 90 bar, for example from 90 to 300 bar, preferably from 90 to 250 bar, more preferably from 90 to 200 bar and especially from 90 to 150 bar.

The pressure can be built up either by hydrogen alone or by a mixture of hydrogen with an inert gas, such as nitrogen, argon or carbon dioxide, and/or, in the case that the reduction is performed in the presence of ammonia (for further details of this embodiment see below), also with ammonia. When a mixture of hydrogen and inert gas and/or ammonia is used, the partial pressure of hydrogen must of course be sufficiently high that the reduction of the compound V can succeed. The partial pressure of hydrogen in the mixture is at least 50%, more preferably at least 70% and especially at least 80% of the total pressure. The pressure is preferably built up solely by hydrogen.

Hydrogen can be used in the form of hydrogen-containing gas mixtures, for example in the form of a technical gas, i.e. with a certain proportion of extraneous gases, for example with up to 5% by volume of extraneous gases, or in pure form, i.e. in a purity of at least 98% by volume, preferably of at least 99% by volume and especially of at least 99.5% by volume of hydrogen, based on the total volume. Examples of hydrogen-containing gas mixtures are those from the reforming process. Preference is given to using hydrogen in pure form.

Hydrogen is used in an equimolar amount or preferably in a molar excess based on the compound V to be reduced. The molar ratio of hydrogen used to compound V used is preferably from 1:1 to 100:1, more preferably from 1:1 to 20:1 and especially from 1.5:1 to 10:1.

The pressures stated above are based on the pressure prevailing at the start of the reaction. In the case of performance of process A in batchwise mode in particular, this can fall in the course of the reaction, for example to the degree in which hydrogen is consumed. When the pressure drop is a maximum of 20%, preferably a maximum of 10% and especially a maximum of 5% of the starting pressure, the pressure need not be reset to the value of the starting pressure. Of course, it can, though, be brought to the value of the starting pressure or even to an even higher pressure, for example by again injecting hydrogen and/or inert gas and/or ammonia, preferably hydrogen, if appropriate in a mixture with inert gas.

The pressures stated above are based on the value of the pressure at the prevailing reaction temperature.

The reaction is effected preferably at a temperature of from 0 to 250° C., especially preferably from 20 to 200° C., more preferably from 50 to 200° C., even more preferably from 80 to 200° C. and especially from 100 to 200° C., for example from 120 to 180° C. or from 140 to 180° C.

The reaction can be effected either in bulk or in a suitable solvent. Preference is given to effecting the reaction in a suitable solvent. Suitable solvents are those which are inert under the given reaction conditions, i.e. react neither with the reactants nor with the reaction product, and which are in particular not hydrogenated themselves under the reaction conditions. Examples of suitable solvents are alkanes, such as pentane, hexane, heptane and the like, cycloalkanes, such as cyclopentane, cyclohexane and methylcyclohexane, aromatic hydrocarbons such as benzene, toluene and the xylenes, halogenated hydrocarbons such as methylene chloride, chloroform, carbon tetrachloride, chlorobenzene and the dichlorobenzenes, high-boiling ethers such as diethylene glycol, triethylene glycol and higher polyethers, and nitriles such as acetonitrile, propionitrile and benzonitrile. Preferred solvents are the aforementioned aromatic hydrocarbons, especially toluene.

In a preferred embodiment of the process A according to the invention, the reduction, i.e. the reaction of the compound V with hydrogen, is performed in the presence of a base. Suitable bases are, for example, alkali metal hydroxides such as sodium hydroxide or potassium hydroxide, alkali metal alkoxides such as sodium methoxide, sodium ethoxide, sodium tert-butoxide and potassium tert-butoxide, N-containing basic heterocycles such as pipiridine, piperazine, morpholine, pyridine, picoline and lutidine, ammonia and amines. Preferred bases are those which are at least partly soluble in the reaction medium of the reduction reaction. In the case of use of the solvents specified above, they are in particular N-containing basic heterocycles, ammonia and amines. Particularly preferred bases are ammonia and amines, especially those of the formula NR^{a}R^{b}R^{c}, in which R^{a}, R^{b} and R^{c} are each independently H, C₁-C₁₀-alkyl, C₁-C₁₀-hydroxyalkyl, C₃-C₁₀-cycloalkyl, aryl or aryl-C₁-C₄-alkyl, where at least one of the R^{a}, R^{b} and R^{c} radicals is not H. Examples of such amines are methylamine, dimethylamine, trimethylamine, ethylamine, diethylamine, triethylamine, propylamine, dipropylamine, tripropylamine, isopropylamine, diisopropylamine, diisopropylethylamine, butylamine, dibutylamine, tributylamine, ethanolamine, diethanolamine, triethanolamine, cyclohexylamine, aniline, benzylamine and the like. In particular, ammonia is used.

The molar ratio of base used to compound V used is preferably from 1:1 to 10:1, more preferably from 1:1 to 3:1 and especially from 1:1 to 2:1.

Alternatively, the reduction is not effected in the presence of a base.

In an alternatively preferred embodiment of the process A according to the invention, the reduction is performed in the presence of a Lewis acid. Preferred Lewis acids are the chlorides of (semi)metals with an electron vacancy, such as boron trichloride, aluminum trichloride, silicon tetrachloride, tin(IV) chloride, titanium(IV) chloride, vanadium(V) chloride, iron(III) chloride and zinc chloride, particular preference being given to zinc chloride, tin(IV) chloride, iron(III) chloride and especially aluminum chloride.

The molar ratio of Lewis acid used to compound V used is, based on each PZ₂ group, preferably from 4:1 to 1:10, more preferably from 2:1 to 1:2.

The reaction time depends upon factors including the batch size, the reaction pressure and the reaction temperature, and can be determined in the individual case by the person skilled in the art, for example by simple preliminary experiments.

The reaction can be configured either as a batch method or semicontinuously or continuously.

Suitable reactors are all reaction vessels for pressure reactions known to those skilled in the art, such as autoclaves, pressure reactors and tubular pressure reactors.

In batchwise operation, the procedure is generally to initially charge the compound V, if appropriate in a solvent and if appropriate in a mixture with a base, in a suitable reaction vessel which is preferably inertized beforehand or afterward, for example by repeatedly injecting hydrogen and/or inert gas, such as nitrogen, argon or carbon dioxide, and decompressing. Subsequently, hydrogen, if appropriate in a mixture with an inert gas and/or ammonia, is injected up to the desired starting pressure. The reaction temperature is preferably established before the injection of the hydrogen. When the pressure falls too greatly, hydrogen and/or inert gas and/or ammonia, preferably hydrogen and if appropriate inert gas and especially only hydrogen is again introduced up to the desired pressure. After the reaction has ended, the vessel is decompressed and the reaction product is worked up as described below.

In continuous operation, the reactants, if appropriate an inert gas, if appropriate a solvent and if appropriate a base are passed through a suitable pressure reactor which has been established to the desired pressure and the desired temperature. The effluent can be recirculated repeatedly if desired.

In the reduction reaction, in the case of a reaction without base, the hydrohalide of the compound I is generally formed. The halide ion stems from the compound V used as the reactant, i.e., in the case of use of compounds V in which Z is chlorine, the reactant obtained in a reaction without base is the corresponding compound I, generally initially in the form of its hydrochloride. This can then be isolated and purified by customary processes. For example, the solvent which may be present can be removed, for example by distillation, suitably under reduced pressure. Since the solvents used are generally those in which the hydrohalide formed is only sparingly soluble, if at all, removal by filtration or decantering is also possible and, owing to the easier industrial performability, regularly also preferred. The remaining solid can then be purified by customary processes, for example by washing, digestion or recrystallization. Before the removal of the solvent, the reaction mixture can also first be admixed with another solvent in which the hydrohalide is even more insoluble, generally an even more nonpolar solvent, in order to facilitate a removal via filtration or decantation.

The free phosphine is prepared from the hydrohalide by means of customary methods for releasing free bases from their acid addition salts, for example thermally, if appropriate in combination with stripping-out of the hydrohalic acid released. The stripping is effected, for example, by introducing an inert gas, such as nitrogen, carbon dioxide or argon, in a sufficiently strong gas flow. Alternatively, the release is effected by reacting the hydrohalide with a base. Suitable bases are those mentioned above. Preference is given to using inorganic bases, preference being given to alkali metal hydroxides such as sodium hydroxide or potassium hydroxide. The reaction is generally effected in a polar solvent in which the hydrohalide is soluble, but the free base is only sparingly soluble, if at all, for example water, C₁-C₃-alkohols such as methanol, ethanol, propanol or isopropanol, or mixtures thereof. The free base formed is then isolated by means of customary processes, for example by filtration, sedimentation, centrifugation or extraction with a nonpolar solvent.

It is also possible to convert the initially formed hydrohalide directly, i.e. without preceding purification, to the free base, and then to subject it to suitable purification steps; however, the first variant is preferred.

In the case of a reaction in the presence of a base, in particular when the base is used in excess or at least in an equimolar amount, the free phosphine I is formed directly. After removal of any solvent present, excess base and the reaction products of the base with the halogen acid formed in the hydrogenation, it is, if desired, purified by means of customary processes. For instance, the compound I, which is generally present dissolved in the solvent, can be removed from solid constituents, for example from the reaction products formed from the base with the halogen acid (e.g. ammonia salts), for example by filtration or decantering, can be free from the solvent, for example by distilling, suitably under reduced pressure, and can then be purified further if desired, for example by means of extractive, distillative or chromatographic methods.

Owing to the oxidation sensitivity of phosphines I and their acid addition salts, the reactants are converted and the products are isolated and purified preferably with exclusion of oxygen; for example, preference is given to using inertized apparatus and possibly also degassed solvents, and contact with air is avoided.

The compound V used as the reactant in the process A according to the invention is preferably obtainable by reacting a corresponding compound VII

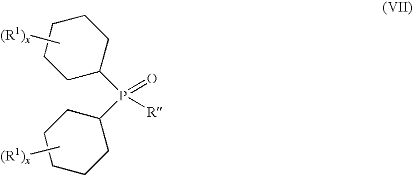

in which
R″ is a radical of the formula II or a linear or branched alkyl radical which has from 1 to 8 carbon atoms and bears 1, 2, 3 or 4 radicals of the formula VIII

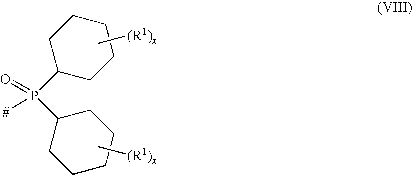

and may also bear from 1 to 4 substituents of the formula IV; and
R¹, x and # are each as defined above;
   with a halogenating agent.

Suitable halogenating agents are all customary halogenating agents, such as phosgene, the tri- and pentahalides of phosphorus, such as phosphorus trichloride, phosphorus tribromide, phosphorus pentachloride and phosphorus dibromide trifluoride, the pentahalides of antimony and of arsenic, such as antimony pentachloride, antimony pentabromide, arsenic pentafluoride, arsenic pentachloride and arsenic pentabromide, thionyl chloride, oxalyl chloride, sulfur tetrafluoride and the like, preference being given to phosgene, phosphorus trichloride, thionyl chloride and oxalyl chloride and especially phosgene, phosphorus trichloride and thionyl chloride. Especially phosgene is used.

The halogenation can be effected in analogy to known processes for converting phosphine oxides to the corresponding phosphine dihalides, as described, for example, in U.S. Pat. No. 4,727,193, DE 1192205, DE 1259883, DE 19532310, Z. Anorg. Allg. Chem. 369, 1969, 33, Chem. Ber. 92, 1959, 2088 and Houben-Weyl, Methoden der Organischen Chemie [Methods of organic chemistry], vol. 12/1, 1963, 129.

The reaction is effected preferably in a suitable solvent. Suitable solvents are those which are inert under the given reaction conditions, i.e. react neither with the reactants nor with the reaction product and which in particular are not themselves halogenated under the reaction conditions. Examples of suitable solvents are alkanes such as pentane, hexane, heptane and the like, cycloalkanes such as cyclopentane, cyclohexane and methylcyclohexane, aromatic hydrocarbons such as benzene, toluene and the xylenes, and halogenated hydrocarbons such as methylene chloride, chloroform, carbon tetrachloride, chlorobenzene and the dichlorobenzenes. When the intention is to use the phosphine dihalide V obtained in the halogenation reaction in the next reduction reaction without workup or isolation, the solvent is of course favorably selected such that it is also suitable for the subsequent reduction step. Preferred solvents are the aforementioned aromatic hydrocarbons, especially toluene.

Since the halogenation reaction generally proceeds exothermically, the reaction is preferably effected with cooling or at least in such a way that evaporating solvent cannot escape and is condensed back into the reaction vessel. In addition, the halogenating agent is preferably not added all at once, but rather continuously or in portions, such that the exothermicity of the reaction can be controlled.

The halogenating agent is used, in relation to the compound VII, at least in an equimolar amount and preferably in a molar excess, these molar data relating to the halogen atoms which are capable of halogenation and are present in the halogenating agent. The molar ratio of reactive halogen atoms present in the halogenating agent (i.e. of halogen atoms which are capable of halogenation and are present in the halogenating agent) to the phosphine oxide VII is preferably from 1:1 to 100:1, especially preferably from 1:1 to 50:1, more preferably from 1:1 to 20:1, even more preferably from 1:1 to 10:1 and especially from 1:1 to 5:1, for example from 1:1 to 3:1 or to 2:1.

On completion of reaction, the reaction mixture is freed of excess halogenating agent by means of customary processes, for example by stripping with an inert gas. The reaction product can then be isolated by common processes and, if desired, also purified. In general, however, the purity is sufficient and the product can be used in the next step without further purification steps. When the solvent which has been selected is one which can also be used in the subsequent reduction step (reduction to the compound I or hydrohalide thereof), the phosphine dihalide V need not be isolated either, but rather can be used in the subsequent step in the form of the entire reaction solution which, though, has preferably been freed from halogenating agent.

Owing to the hydrolysis sensitivity of the compound V, it is self-evident that the halogenation reaction and also any workup and purification steps which follow, and also the further reaction (reduction), should take place under substantially anhydrous conditions, for example by using dry and, if appropriate, inertized reaction vessels and anhydrous solvents and reactants.

The compound VII used in the halogenation reaction is, for example, obtainable in step (a) of the process B described below or in the process C described below.

The present invention further provides a process for preparing compounds I or hydrohalides thereof, comprising the following steps:
(a) hydrogenating compounds of the formula IX

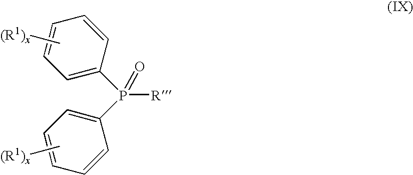

in which
R′″ is a radical of the formula X

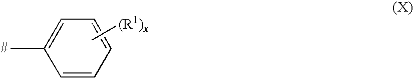

or a linear or branched alkyl radical which has from 1 to 8 carbon atoms and bears 1, 2, 3 or 4 radicals of the formula XI

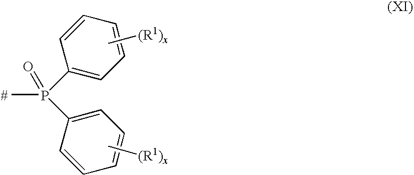

and may also bear from 1 to 4 substituents of the formula IV as defined above;
to give compounds of the formula VII as defined above;
(b) reacting the compounds of the formula VII obtained in step (a) with a halogenating agent to obtain compounds of the formula V as defined above;
(c) reacting the compounds of the formula V obtained in step (b) with a reducing agent to obtain compounds I or a hydrohalide thereof.

This process is referred to below as process B.

The hydrogenation step (a) of the process B according to the invention can be performed in accordance with customary prior art processes for reducing aromatics to the corresponding cycloalkanes and especially for reducing aryl-substituted, especially phenyl-substituted, phosphine oxides to the corresponding cycloalkyl-substituted phosphine oxides.

The hydrogenation is effected generally in the presence of a suitable hydrogenation catalyst. The hydrogenation catalyst used may generally be all prior art catalysts which catalyze the hydrogenation of aromatics to the corresponding cycloalkanes and especially of aryl- and especially phenyl-substituted phosphine oxides to the corresponding cycloalkyl-substituted phosphine oxides. The catalysts may be used either in heterogeneous phase or as homogeneous catalysts. The hydrogenation catalysts preferably comprise at least one metal of group VIII.

Particularly suitable metals of group VIII are selected from ruthenium, cobalt, rhodium, nickel, palladium and platinum, and especially from ruthenium, rhodium, nickel and platinum. More preferably, the hydrogenation catalysts comprise ruthenium as the active metal.

The metals may also be used as mixtures. In addition, the catalysts, as well as the metals of group VIII, may also comprise small amounts of further metals, for example metals of group VIIb, especially rhenium, or metals of group Ib, i.e. copper, silver or gold.

When a heterogeneous catalyst is used, it is suitably present in finely divided form. The finely divided form is achieved, for example, as follows:
a) black catalyst: shortly before use as a catalyst, the metal is precipitated reductively from the solution of one of its salts.
b) Adams catalyst: the metal oxides, especially the oxides of platinum, palladium and also ruthenium, are reduced in situ by the hydrogen used for the hydrogenation.
c) Skeletal or Raney catalyst: the catalyst is prepared as a “metal sponge” from a binary alloy of the metal (especially nickel or cobalt) with aluminum or silicon by leaching one partner out with acid or alkali. Residues of the original alloy partner often act synergistically.
d) Supported catalyst: black catalysts can also be precipitated on the surface of a support substance. Suitable supports and support materials are described below.

Such heterogeneous catalysts are described in general form, for example, in Organikum, 17th edition, VEB Deutscher Verlag der Wissenschaften, Berlin, 1988, page 288. In addition, heterogeneous hydrogenation catalysts which are suitable for the reduction of aromatics to cycloalkanes are described in detail in the following documents:

U.S. Pat. No. 3,597,489, U.S. Pat. No. 2,898,387 and GB 799,396 describe the hydrogenation of benzene to cyclohexane over nickel and platinum catalysts in the gas or liquid phase. GB 1,155,539 describes the use of a rhenium-doped nickel catalyst for hydrogenating benzene. U.S. Pat. No. 3,202,723 describes the hydrogenation of benzene with Raney nickel. Ruthenium-containing suspension catalysts which have been doped with palladium, platinum or rhodium are used in SU 319582 for hydrogenating benzene to cyclohexane. Aluminum oxide-supported catalysts are described in U.S. Pat. No. 3,917,540 and U.S. Pat. No. 3,244,644. The hydrogenation catalysts described in these documents are fully incorporated by way of reference.

The following documents specifically describe the conversion of phenyl-substituted phosphine oxides to cyclohexyl-substituted phosphine oxides: the use of rhodium(III)/-platinum(IV) mixed oxides is described, inter alia, in Catalysis Letters, 1991, 8(1), 23-26 and in DD 283633. In Chem. Lett. 1986, 12, 2061-2064 and in Chem. Soc., Chem. Commun. 1984, 24, 1641-1643, aluminum oxide-supported rhodium catalysts are used. The use of platinum as a hydrogenation catalyst is described, for example, in Zh. Obshch. Khim. 41(103), 1971, 1944-1950, in Zh. Obshch. Khim. 38, 1968, 10, 2346-2347 and in Izv. Akad. SSSR 1967, 4, 949-950. In Zh. Obshch. Khim. 55(117), 1985, 2667-2674, in Chem. Pharm. Bull. 40(11), 1992, 2921-2926 and in Angew. Chem. Int. Ed. 40(7), 2001, 1235-1238, Raney nickel is used as the hydrogenation catalyst. The use of ruthenium supported on carbon is described in Chem. Lett. 1984, 9, 1603-1606.

According to the configuration of the hydrogenation process, the support material may have various forms. When the hydrogenation is performed, for example, with a mobile catalyst phase, for example in a suspension reactor, for example in a stirred tank, a moving bed reactor, fluidized bed reactor or bubble column reactor, the support material is generally used in the form of a finely divided powder. When the hydrogenation, in contrast, is performed with an immobile catalyst phase and the catalyst is used in the form of a fixed bed catalyst, for example in a liquid-phase reactor or trickle reactor, usually shaped bodies are used as support materials. Such shaped bodies may be present in the form of spheres, tablets, cylinders, hollow cylinders, Raschig rings, extrudates, saddles, stars, spirals, etc., with a size (measurement of longest dimension) of from about 1 to 30 mm. Moreover, the supports may be present in the form of monoliths, as described, for example, in DE-A-19642770. In addition, the supports may be used in the form of wires, sheets, grilles, meshes, fabrics and the like.

The supports may consist of metallic or nonmetallic, porous or nonporous material.

Suitable metallic materials are, for example, highly alloyed stainless steel. Suitable nonmetallic materials are, for example, mineral materials, for example natural and synthetic minerals, glasses or ceramics, polymers, for example synthetic or natural polymers, or a combination of the two.

Preferred support materials are carbon, especially activated carbon, silicon carbide, (semi)metal oxides such as silicon dioxide, especially amorphous silicon dioxide, aluminum oxide, magnesium oxide, titanium dioxide, zirconium dioxide and zinc oxide, and also the sulfates and carbonates of the alkaline earth metals, such as calcium carbonate, calcium sulfate, magnesium carbonate, magnesium sulfate, barium carbonate and barium sulfate.

The catalyst can be applied to the support by customary processes, for example by impregnating, wetting or spraying the support with a solution which comprises the catalyst or a suitable precursor thereof.

Suitable supports and processes for applying the catalyst to them are described, for example, in DE-A-10128242, which is hereby fully incorporated by reference.

Homogeneous hydrogenation catalysts can also be used in the process B according to the invention. Examples thereof are the nickel catalysts which are described in EP-A-0668257. Disadvantages in the case of use of homogeneous catalysts are, however, their preparation costs and also the fact that they generally cannot be regenerated.

Therefore, in the process according to the invention, preference is given to using heterogeneous hydrogenation catalysts.

Examples of supported catalysts are palladium, nickel or ruthenium on carbon, especially activated carbon, silicon dioxide, especially amorphous silicon dioxide, silicon carbide, barium carbonate, calcium carbonate, magnesium carbonate or aluminum oxide, and the supports may be present in the shapes described above. A preferred support shape is that of the above-described shaped bodies. A particularly preferred support is aluminum oxide.

The metallic catalysts may also be used in the form of their oxides, especially palladium oxide, platinum oxide, rhodium oxide, ruthenium oxide or nickel oxide, which are then reduced to the corresponding metals under the hydrogenation conditions. These too may be used in supported form. Preferred supports here too are selected from carbon, especially activated carbon, silicon dioxide, especially amorphous silicon dioxide, silicon carbide, barium carbonate, calcium carbonate, magnesium carbonate and especially aluminum oxide, and the supports may be present in the shapes described above. A preferred support shape is that of the above-described shaped bodies.

One example of a metal sponge is Raney nickel.

In step (a) of the process B according to the invention, particular preference is given to using a ruthenium-containing hydrogenation catalyst which preferably comprises metallic ruthenium which is optionally supported, or especially ruthenium(IV) oxide, which may likewise be supported. With regard to suitable and preferred ruthenium catalysts and configurations of the hydrogenation step (a) in the case of use of ruthenium catalysts, reference is made to the remarks for the process C according to the invention.

The amount of catalyst to be used depends upon factors including the particular catalytically active metal and its use form and can be determined by the person skilled in the art in the individual case. Quite generally, the hydrogenation catalyst may be used in an amount of from 0.01 to 70% by weight, preferably from 0.05 to 20% by weight and especially from 0.1 to 10% by weight, based on the weight of the compound IX to be hydrogenated. The amount of catalyst specified is based on the amount of active metal, i.e. on the catalytically active component of the catalyst. Noble metal catalysts are used regularly in an amount smaller by the factor of 10 than base metal catalysts.

The hydrogenation is effected at a temperature of preferably from 0 to 250° C., especially preferably from 20 to 200° C., more preferably from 50 to 200° C. and especially from 100 to 180° C.

The reaction pressure of the hydrogenation reaction is preferably in the range from 1 to 300 bar, especially preferably from 10 to 300 bar, more preferably from 50 to 300 bar and especially from 100 to 300 bar.

The pressure can be built up either by hydrogen alone or by a mixture of hydrogen with an inert gas, such as nitrogen, argon or carbon dioxide. When a mixture of hydrogen and inert gas is used, the partial pressure of hydrogen must of course be sufficiently high that the hydrogenation of the phosphine oxide IX can succeed. The partial pressure of hydrogen in the mixture is preferably at least 50%, more preferably at least 70% and especially at least 80% of the total pressure. Preference is given to building up the pressure solely by means of hydrogen.

Hydrogen may be used in the form of hydrogen-containing gas mixtures, for example in the form of a technical gas, i.e. with a certain proportion of extraneous gases, for example with up to 5% by volume of extraneous gases, or in pure form, i.e. in a purity of at least 98% by volume, preferably of at least 99% by volume and especially of at least 99.5% by volume of hydrogen, based on the total volume. Examples of hydrogen-containing gas mixtures are those from the reforming process. Preference is given to using hydrogen in pure form.

Both reaction pressure and reaction temperature depend upon factors including the activity and amount of the hydrogenation catalyst used and can be determined in the individual case by the person skilled in the art.

Hydrogen is used in a molar excess, based on the compound I× to be reduced. The molar ratio of hydrogen used to compound IX used is preferably from 500:1 to 10:1, more preferably from 100:1 to 10:1 and especially from 50:1 to 10:1.

The above pressure data are based on the pressure prevailing at the start of the reaction. In the case of performance of step (a) of process B in batchwise operation in particular, this can fall in the course of the reaction, for example to the degree in which hydrogen is consumed. When the pressure drop is a maximum of 20%, preferably a maximum of 10% and especially a maximum of 5% of the starting pressure, the pressure need not be reset to the value of the starting pressure. Of course, it can, though, be brought to the value of the starting pressure or even to an even higher pressure, for example by again injecting hydrogen and/or inert gas, preferably hydrogen, if appropriate in a mixture with inert gas.

The above pressure data are based on the value of the pressure at the prevailing reaction temperature.

The hydrogenation is effected preferably in a suitable solvent. Suitable solvents are those which are inert under the reaction conditions, i.e. neither react with the reactant or product nor are themselves altered. In particular, suitable solvents are not themselves hydrogenated under the hydrogenating conditions. The solvents are preferably saturated, i.e. they do not comprise any C—C double bonds. The suitable solvents include alkanes, especially C₅-C₁₀-alkanes such as pentane, hexane, heptane, octane, nonane, decane and isomers thereof, cycloalkanes, especially C₅-C₈-cycloalkanes such as cyclopentane, cyclohexane, cycloheptane or cyclooctane, open-chain and cyclic ethers such as diethyl ether, methyl tert-butyl ether, tetrahydrofuran or 1,4-dioxane, ketones such as acetone or ethyl methyl ketone, alcohols, especially C₁-C₃-alkanols such as methanol, ethanol, n-propanol or isopropanol, and also carboxylic acids such as acetic acid and propionic acid. Also suitable are mixtures of the aforementioned solvents and mixtures thereof with water. Preference is given to polar solvents, such as the abovementioned cyclic ethers, especially tetrahydrofuran or 1,4-dioxane, the abovementioned ketones, alcohols, carboxylic acids, mixtures thereof or mixtures with water. Especially aqueous or nonaqueous acetone, ethanol or methanol in pure form or in a mixture with water or acetic acid, acetic acid in the form of glacial acetic acid or in the form of aqueous acetic acid or especially tetrahydrofuran are used.

The hydrogenation step (a) can be configured either continuously or batchwise.

The hydrogenation is performed in batchwise operation generally by initially charging the compound IX and the catalyst in the solvent and then beginning the hydrogen introduction. Depending on the hydrogenation catalyst used, the hydrogenation is effected at elevated temperature and/or at elevated pressure. The workup is generally effected as described below. When elevated pressure is not employed, the customary prior art reaction apparatus for batchwise processes which is suitable for standard pressure is possible. Examples thereof are suspension reactors for batchwise operation, for example customary stirred tanks which are preferably equipped with evaporative cooling, suitable mixers, introduction apparatus, if appropriate heat exchanger elements and/or inertization apparatus. In general, however, it is necessary to work under elevated pressure.

When the hydrogenation step (a) is configured as a continuous process, the exact procedure depends on the type of catalyst used and especially on whether it is arranged in the reactor in mobile (for example as suspended particles) or immobile (i.e. as a fixed bed catalyst) form. Suitable reactors for the use of mobile catalyst phases are continuous suspension reactors, such as continuous stirred tanks, moving bed reactors, fluidized bed reactors and bubble column reactors. Suitable fixed bed reactors are, for example, liquid-phase reactors and trickle reactors. The reaction is generally effected according to the procedure for triphasic reactions customary for the particular reactors.

For the reaction under pressure, the customary pressure vessels known from the prior art, such as autoclaves, stirred autoclaves and pressure reactors, may be used.

The hydrogenation is effected preferably in a suspension reactor or in a fixed bed reactor, preferably under elevated pressure.

After the hydrogenation has ended, the catalyst and the solvent are generally removed. The heterogeneous catalyst is preferably removed by filtration or by sedimentation and removal of the upper product-containing phase. Other removal methods for removing solids from solutions, for example centrifugation, are suitable for removing the heterogeneous catalyst. Homogeneous catalysts are removed by customary processes for separating monophasic mixtures, for example by chromatographic methods. If appropriate, according to the catalyst type, it may be necessary to deactivate it before the removal. This can be done by customary processes, for example by washing the reaction solution with protic solvents, for example with water or with C₁-C₃-alkanols, such as methanol, ethanol, propanol or isopropanol, which are basified or acidified if required.

The solvent is removed by customary processes, for example by distillation, especially under reduced pressure.

The resulting product can, if desired, be purified by means of customary methods, for example by distillation.

With regard to suitable and preferred embodiments of the halogenation step (b), reference is made to the remarks made above for process A for the preparation of the compound V used as the reactant there.

The reduction step (c) of the process B according to the invention can be performed in analogy to prior art processes for reducing phosphine dihalides substituted by three hydrocarbon radicals, especially triphenylphosphine dihalides, to the correspondingly substituted phosphines, especially triphenylphosphine.

The reducing agents used may be base metals, for example the metals of the first to fifth main group, and the transition group elements which are not noble metals, in particular those of groups IIIb (Sc, Y, La), IVb (Ti, Zr, Hf), Vb (V, Nb, Ta), VIb (Cr, Mo, W), VIIb (Mn, Tc, Re), VIII (Fe, Co, Ni) and IIb (Zn), and additionally semimetals such as boron, silicon, arsenic, selenium and tellurium, complex metal hydrides such as lithium aluminum hydride, elemental phosphorus, elemental carbon or hydrogen.

It is self-evident that the selection of the reducing agent also depends on the nature of the R¹ radical, which should remain unchanged under the reduction conditions. For example, lithium aluminum hydride is not used as the reducing agent when R¹ is an ester radical (R¹═COR³; R³═OR⁴). It is known to those skilled in the art which reducing agents are critical for which R¹ radicals.

The use of hydrogen as a reducing agent is described separately; the remarks which follow relate exclusively to the use of the metals and semimetals mentioned, of phosphorus or carbon as reducing agents.

Preferred metals are those of the first main group, in particular lithium, sodium or potassium, particular preference being given to sodium, of the second main group, in particular magnesium, and of the third main group, in particular aluminum, and also iron as a transition group element. Among these, particular preference is given to sodium and aluminum.

The preferred semimetal is silicon. This can be used in elemental form or as an alloy, for example as ferrosilicon.

Phosphorus can be used either in the white modification or in the red modification.

The reduction of the compounds V to corresponding compounds I using base metals, semimetals, complex metal hydrides, elemental phosphorus or elemental carbon can be performed, for example, in analogy to the processes described in the documents which follow: DE-A-1259883 (reduction in the presence of zinc, manganese, magnesium or especially aluminum), DE-A-2638720 (reduction with sodium), U.S. Pat. No. 3,780,111 (reduction with iron), DE-A-19532310 (reduction in the presence of base metals or semimetals, in particular of iron, silicon, magnesium or especially aluminum), Chem. Ber. 92, 2088 (1959) (reduction with sodium), Chem. Ber. 91, 1583 (1958) (reduction with lithium aluminum hydride), Z. Anorg. Allg. Chem., volume 369, 1969, 33 (reduction with phosphorus), DE-A-4142679 (reduction with elemental silicon or silicon alloys) and U.S. Pat. No. 4,727,193 (reduction with elemental carbon).

It is self-evident that the selection of a suitable reducing agent also depends on the R¹ radical, which generally should not be altered under the reaction conditions. For example, in the case that R¹ is an ester radical (R¹═COR³; R³═OR⁴), the reducing agent selected will not be lithium aluminum hydride, since this is known to be a good reducing agent for ester groups. The selection of suitable reducing agents depending on the particular R¹ radical can be made by the person skilled in the art with the aid of relevant literature.

The reduction is effected generally in a suitable, usually high-boiling, aprotic and relatively polar solvent or, in particular when the reactants are present in the liquid phase at the desired reaction temperature, also in substance. Suitable solvents are inert under the given reaction conditions, i.e. they react neither with the reactants nor with the products, and are especially not themselves reduced. The selection of a suitable solvent depends not only on the desired reaction temperature but also on the reducing agent used. In the case of use of base metals, semimetals or silicon as the reducing agent, suitable solvents are, for example, aromatic hydrocarbons such as benzene, toluene or the xylenes, halogenated hydrocarbons, in particular halogenated aromatic hydrocarbons such as chlorobenzene or the dichlorobenzenes, nitriles, in particular aromatic nitriles such as benzonitrile, and also high-boiling ethers such as diethylene glycol, triethylene glycol and higher polyethers. In the case of use of elemental carbon, for example, hydrocarbons, including technical hydrocarbon mixtures, and especially alkanes are suitable solvents.

The reaction temperature is generally relatively high and is, for example, from 100 to 300° C., preferably from 100 to 200° C.

The reaction pressure is generally of minor importance; it is possible to work either at reduced pressure or at standard pressure, or elevated pressure of, for example, up to 10 bar, one possibility being a reaction at ambient pressure.

The reducing agents are generally used in a very finely divided form in order to enable a minimum reaction time, for example in the form of powders, turnings, wools, sponges or suspensions.

The reaction time depends on the batch size, the reduction potential of the reducing agent used, the reaction temperature and further factors, and has to be determined in the individual case by the person skilled in the art, which can be done, for example, with reference to simple preliminary experiments.

The workup after the reaction has ended is effected in a customary manner. For instance, the excess reducing agent, which is generally present in heterogeneous phase, is removed by customary processes, such as filtration, decantation or centrifugation, and the compound I is removed from solvent and any reaction product of the reducing agent still present (i.e. reducing agent in its oxidized form), which can be done, for example, by distillation or extraction.

The resulting reaction product can then, if desired, be subjected to further purification steps, such as recrystallization, in particular by precipitation in the form of a hydrogen halide addition salt of the phosphine I, extraction or column chromatography.

Owing to the oxidation sensitivity of the phosphine I formed, it is self-evident that all reaction, workup and purification steps have to be effected with exclusion of oxygen.

Preference is given to effecting the reduction in step (c) of the process B according to the invention, however, with use of hydrogen as the reducing agent. With regard to suitable and preferred process measures in the case of use of hydrogen as a reducing agent, reference is made to the remarks for process A.

Finally, the invention provides a process for preparing compounds of the formula VII as defined above, comprising the following step:

reacting compounds of the formula IX as defined above with hydrogen in the presence of a ruthenium-based hydrogenation catalyst.

This process is referred to hereinafter as process C.

The ruthenium-based hydrogenation catalyst may be either a heterogeneous catalyst or a homogeneous catalyst. It is preferably selected from catalysts which are based on ruthenium(IV) oxide, the hydrate thereof, ruthenium(VIII) oxide, the hydrate thereof, elemental ruthenium, elemental ruthenium in a mixture with at least one metal of group VIIb, VIII or Ib, coordination compounds of ruthenium with ligands such as carbonyl, triphenylphosphine and halides, or ruthenium salts such as ruthenium chloride or ruthenium nitrate. The hydrogenation catalyst is preferably a heterogeneous catalyst and is thus preferably based on ruthenium(IV) oxide, the hydrate thereof, ruthenium(VIII) oxide, the hydrate thereof, elemental ruthenium or elemental ruthenium in a mixture with at least one metal of group VIIb, VIII or Ib. The catalyst is more preferably based on ruthenium(IV) oxide, the hydrate thereof, elemental ruthenium or elemental ruthenium in a mixture with at least one metal of group VIIb, VIII or Ib, and especially on ruthenium(IV) oxide or the hydrate thereof.

In one embodiment, the ruthenium catalyst is preferably supported. Preference is given to applying elemental ruthenium or ruthenium(IV) oxide (or the hydrate thereof), to a suitable support. Suitable supports are listed above in the description of step (a) of process B; they may consist of metallic or nonmetallic, porous or nonporous material. Preferred supports are selected from carbon, especially activated carbon, silicon carbide, (semi)metal oxides such as silicon dioxide, especially amorphous silicon dioxide, aluminum oxide, magnesium oxide, titanium dioxide, zirconium dioxide and zinc oxide, and also the sulfates and carbonates of the alkaline earth metals, such as calcium carbonate, calcium sulfate, magnesium carbonate, magnesium sulfate, barium carbonate and barium sulfate. A particularly preferred support is aluminum oxide. Accordingly, a particularly preferred hydrogenation catalyst is ruthenium(IV) oxide (hydrate) supported on aluminum oxide.

A particularly suitable ruthenium hydrogenation catalyst is described in DE-A-2132547, which is hereby fully incorporated by reference. This is a ruthenium oxide hydrate which is obtained by reacting a ruthenium salt, preferably the trihydate of ruthenium(III) chloride, RuCl₃.3H₂O, in aqueous solution with a base, preferably an alkali metal hydroxide, which precipitates the ruthenium oxide hydrate. The catalyst preferably has a particle size of about 40-60 Å, a relatively low ruthenium content of about 40-60% by weight, based on the total weight of the catalyst, and/or a water content of about 10-20% by weight, based on the total weight of the catalyst. When the catalyst is to be used in supported form, the above-described reaction is suitably effected in the presence of the support material onto which it precipitates in the course of its formation. Alternatively, the precipitated ruthenium oxide hydrate can first be isolated, for example by filtration, sedimentation or centrifugation, and only then incorporated into the support material. Suitable support materials are those mentioned above.

Depending on the configuration of the hydrogenation process C, the support material may have various forms. When the hydrogenation is performed, for example, with a mobile catalyst phase, for example in a suspension reactor, for example in a stirred tank, a moving bed, fluidized bed or bubble column reactor, the support material is generally used in the form of a finely divided powder. When the hydrogenation, in contrast, is performed with immobile catalyst phase and the catalyst is used in the form of a fixed bed catalyst, for example in a liquid-phase reactor or trickle reactor, usually shaped bodies are used as support materials. Such shaped bodies may be present in the form of spheres, tablets, cylinders, hollow cylinders, Raschig rings, extrudates, saddles, stars, spirals, etc. with a size (measurement of the longest dimension) of from 1 to 30 mm. Moreover, the supports may be present in the form of monoliths, as described, for example, in DE-A-19642770. In addition, the supports may be used in the form of wires, sheets, grilles, meshes, fabrics and the like.

The amount of catalyst to be used depends upon factors including its use form and can be determined in the individual case by the person skilled in the art. Quite generally, the ruthenium-containing hydrogenation catalyst can be used in an amount of from 0.01 to 20% by weight, preferably from 0.1 to 10% by weight and especially from 0.1 to 5% by weight, based on the weight of the compound I× to be hydrogenated. The amount of catalyst specified is based on the amount of active metal, i.e. on the ruthenium content of the catalyst.

The reaction temperature is preferably from 80 to 200° C., more preferably from 100 to 200° C. and especially from 100 to 180° C.

The reaction is effected preferably at a pressure of from 50 to 350 bar, especially preferably from 80 to 300 bar, more preferably from 100 to 300 bar, in particular from 150 to 300 bar and especially from 170 to 270 bar.

The pressure can be built up either by hydrogen alone or by a mixture of hydrogen with an inert gas, such as nitrogen, argon or carbon dioxide. When a mixture of hydrogen and inert gas is used, the partial pressure of hydrogen must of course be sufficiently high that the hydrogenation of the compound IX can succeed. The partial pressure of hydrogen in the mixture is preferably at least 50%, more preferably at least 70% and especially at least 80% of the total pressure. The pressure is preferably built up solely by means of hydrogen.

Hydrogen can be used in the form of hydrogen-containing gas mixtures, for example in the form of a technical gas, i.e. with a certain proportion of extraneous gases, for example with up to 5% by volume of extraneous gases, or in pure form, i.e. in a purity of at least 98% by volume, preferably of at least 99% by volume and especially of at least 99.5% by volume of hydrogen, based on the total volume. Examples of hydrogen-containing gas mixtures are those from the reforming process. Preference is given to using hydrogen in pure form.

Both reaction pressure and reaction temperature depend upon factors including the activity and amount of the ruthenium catalyst used and can be determined by the person skilled in the art in the individual case.

Hydrogen is used in a molar excess based on the compound I× to be hydrogenated. The molar ratio of hydrogen used to compound IX used is preferably from 500:1 to 10:1, more preferably from 100:1 to 10:1 and especially from 50:1 to 10:1.

The above pressure data are based on the pressure prevailing at the start of the reaction. In the case of performance of the process C in batchwise mode in particular, this can fall in the course of the reaction, for example to the degree in which hydrogen is consumed. When the pressure drop is not more than 20%, preferably not more than 10% and especially not more than 5% of the starting pressure, the pressure need not be reset to the value of the starting pressure. Of course, it can, though, be brought to the value of the starting pressure or even to an even higher pressure, for example by again injecting hydrogen and/or inert gas, preferably hydrogen, if appropriate in a mixture with inert gas.

The above pressure data are based on the value of the pressure at the prevailing reaction temperature.

The hydrogenation is effected preferably in a suitable solvent. Suitable solvents are those which are inert under the reaction conditions, i.e. neither react with the reactant or product nor are altered themselves. In particular, suitable solvents are not themselves hydrogenated under the hydrogenating conditions. The solvents are preferably saturated, i.e. they do not comprise any C—C double bonds. The suitable solvents include alkanes, especially C₅-C₁₀-alkanes such as pentane, hexane, heptane, octane, nonane, decane and isomers thereof, cycloalkanes, especially C₅-C₈-cycloalkanes such as cyclopentane, cyclohexane, cycloheptane or cyclooctane, open-chain and cyclic ethers such as diethyl ether, methyl tert-butyl ether, tetrahydrofuran or 1,4-dioxane, ketones such as acetone or ethyl methyl ketone, alcohols, especially C₁-C₃-alkanols such as methanol, ethanol, n-propanol or isopropanol, and also carboxylic acids such as acetic acid and propionic acid. Also suitable are mixtures of the aforementioned solvents and mixtures thereof with water. Preference is given to polar solvents, such as the abovementioned cyclic ethers, especially tetrahydrofuran or 1,4-dioxane, the abovementioned ketones, alcohols, carboxylic acids, mixtures thereof or mixtures with water. Especially aqueous or nonaqueous acetone, ethanol or methanol in pure form or in a mixture with water or acetic acid, acetic acid in the form of glacial acetic acid or in the form of aqueous acetic acid or especially tetrahydrofuran is used.

The hydrogenation of process C can be configured either continuously or batchwise.

The performance of the hydrogenation in batchwise operation is generally effected by initially charging the compound I× and the catalyst in the solvent, bringing the reaction mixture to the desired temperature and then commencing the hydrogen introduction. The workup is generally effected as described below.

When the hydrogenation is configured as a continuous process, the exact procedure depends on the type of catalyst used and especially on whether it is arranged in the reactor in mobile (for example as suspended particles) or immobile (i.e. as a fixed bed catalyst) form. Suitable reactors for the use of mobile catalyst phases are continuous suspension reactors, such as continuous stirred tanks, moving bed reactors, fluidized bed reactors and bubble column reactors. Suitable fixed bed reactors are, for example, liquid-phased reactors and trickle reactors. The reaction is generally effected according to the procedure for triphasic reactions customary for the particular reactors.

For the reaction under pressure, it is possible to use the customary pressure vessels known from the prior art, such as autoclaves, stirred autoclaves and pressure reactors. The hydrogenation is effected preferably in a suspension reactor or in a fixed bed reactor, preferably under elevated pressure.

After the hydrogenation has ended, the catalyst and the solvent are generally removed. The heterogeneous catalyst is preferably removed by filtration or by sedimentation and removal of the upper product-containing phase. Other removal methods for removing solids from solutions, for example centrifugation, are also suitable for removing the heterogeneous catalyst. Homogeneous catalysts are removed by customary processes for separating monophasic mixtures, for example by chromatographic methods. If appropriate, it may be necessary to deactivate the catalyst before the removal. This can be done by customary processes, for example by washing the reaction solution with protic solvents, for example with water or with C₁-C₃-alkanols such as methanol, ethanol, propanol or isopropanol, which have been basified or acidified if required.

The solvent is removed by customary processes, for example by distillation, especially under reduced pressure.

The resulting product can be purified if desired by means of customary methods, for example by distillation.

The compounds IX used in process B, step (a) or in process C are either known, some of them even being commercially available (such as triphenylphosphine oxide), or may be prepared by means of processes known per se. For example, it is possible to convert commercially available phenyl-substituted phosphines, such as triphenyl phosphine, DIOP, chiraphos and the like, to the corresponding phosphine oxide, for example by oxidation with air, pure oxygen or hydrogen peroxide. A stepwise synthesis of compounds IX in which R′″ is an alkyl radical proceeds from diphenylphosphine chlorides substituted by x R¹ radicals, which are coupled to corresponding di-, tri-, tetra- or pentachloroalkanes in the presence of sodium. The subsequent oxidation of the phosphorus, for example with air, oxygen or hydrogen peroxide, gives rise to the compound IX.

The remarks which follow regarding suitable and preferred compounds and radicals of the formulae I, II, III, IV, V, VI, VII, VIII, IX, X and XI apply either alone or especially in combination with one another and apply to all three processes A, B and C according to the invention.

In compounds I, R is preferably a radical of the formula II. Accordingly R′ in compound V and R″ in compound VII are likewise preferably each a radical of the formula II. Accordingly, R′″ in formula IX is preferably a radical of the formula X.

Alternatively, in compounds I, R is preferably a radical of the formula XII

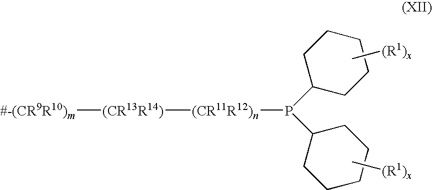

in which
R⁹, R¹⁰, R¹¹ and R¹² are each independently H, methyl or ethyl,
m and n are each independently 0, 1, 2 or 3;
R¹³ and R¹⁴ are each independently H, methyl, ethyl, —CH₂—O—R⁷, in which R⁷ is as defined above, or a radical of the formula XIII

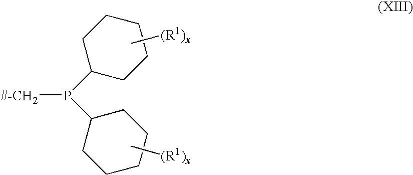

in which R¹, x and # are each as defined above.

Correspondingly, R′ in compounds V is preferably a radical of the formula XIV

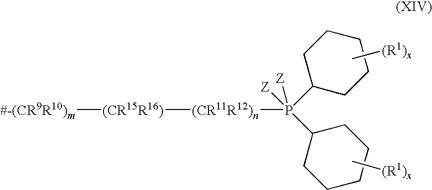

in which
R¹, R⁹, R¹⁰, R¹¹, R¹², m, n, x and # are each as defined in formula XII;
Z is halogen; and
R¹⁵ and R¹⁶ are each independently H, methyl, ethyl, —CH₂—O—R⁷ in which R⁷ is as defined above, or a radical of the formula XV

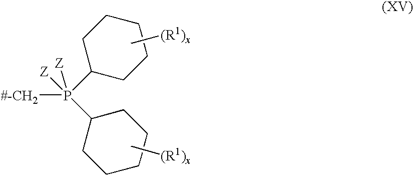

in which R¹, Z, x and # are each as defined above.

Correspondingly, R″ in compounds VII is preferably a radical of the formula XVI

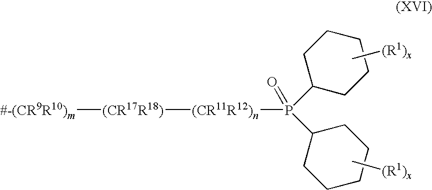

in which
R¹, R⁹, R¹⁰, R¹¹, R¹², m, n, x and # are each as defined in formula XII; and
R¹⁷ and R¹⁸ are each independently H, methyl, ethyl, —CH₂—O—R⁷, in which R⁷ is as defined above, or a radical of the formula XVII

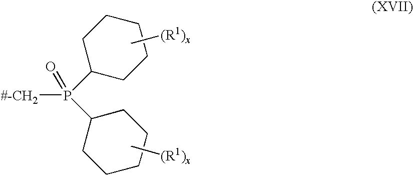

in which R¹, x and # are each as defined above.

Accordingly, R′″ in compounds IX is preferably a radical of the formula XVIII

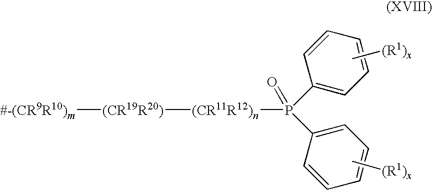

in which
R¹, R⁹, R¹⁰, R¹¹, R¹², m, n, x and # are each as defined in formula XII; and
R¹⁹ and R²⁰ are each independently, H, methyl, ethyl, —CH₂—O—R⁷ in which R⁷ is as defined above, or a radical of the formula XIX

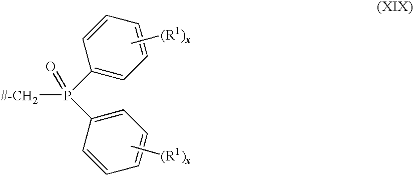

in which R¹, x and # are each as defined above.

In a preferred embodiment, R⁹, R¹⁰, R¹¹, R¹², R¹³, R¹⁴, R¹⁵, R¹⁶, R¹⁷, R¹⁸, R¹⁹, R²⁰ are each H and the sum of m and n is 0, 1, 2 or 3.

In an alternatively preferred embodiment, m is 0, n is 1, R¹¹, R¹³, R¹⁵, R¹⁷ and R¹⁹ are each H, and R¹², R¹⁴, R¹⁶, R¹⁸ and R²⁰ are each methyl or ethyl and especially methyl. This embodiment comprises both the pure threo isomers, the pure erythro isomers and mixtures thereof.

In an alternatively preferred embodiment,

R⁹, R¹⁰, R¹¹ and R¹² are each H;
m and n are each 1;
R¹³ is a radical of the formula XIII;
R¹⁴ is H, methyl, ethyl or a radical of the formula XIII;
R¹⁵ is a radical of the formula XV;
R¹⁶ is H, methyl, ethyl or a radical of the formula XV;
R¹⁷ is a radical of the formula XVII;
R¹⁸ is H, methyl, ethyl or a radical of the formula XVII;
R¹⁹ is a radical of the formula XIX; and
R²⁰ is H, methyl, ethyl or a radical of the formula XIX.

In an alternatively preferred embodiment,

R⁹, R¹⁰, R¹¹ and R¹² are each H;
m and n are each 1;
R¹³, R¹⁵, R¹⁷ and R¹⁹ are each H, methyl or ethyl; and
R¹⁴, R¹⁶, R¹⁸ and R²⁰ are each methyl or ethyl.

R¹ is preferably C₁-C₄-alkyl, C₁-C₄-hydroxyalkyl, C₁-C₄-haloalkyl or halogen.

Z is preferably Cl.

x is preferably 0.

Particularly preferred compounds I are selected from compounds of the formulae I.1, I.2, I.3 and I.4

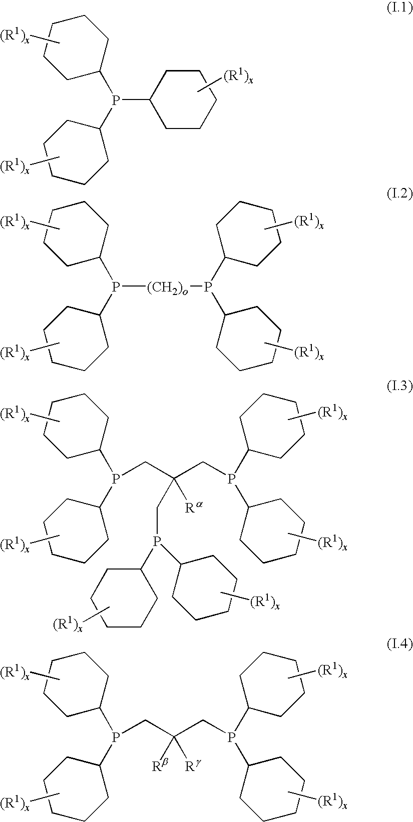

in which R¹ and x are each as defined above, o is 1, 2, 3 or 4, R^{α} is H, methyl, ethyl or a radical of the formula XIII, R^{β} is H, methyl or ethyl, and R^{γ} is methyl or ethyl.

Accordingly, particularly preferred compounds V are selected from compounds V.1, V.2, V.3 and V.4

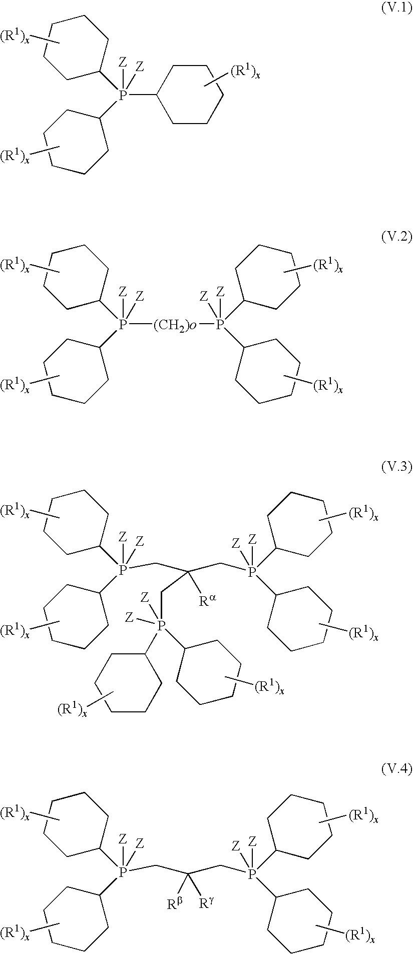

in which R¹, R^{α}, R^{β}, R^{γ}, x and o are each as defined above and Z is halogen.

Accordingly, particularly preferred compounds VII are selected from compounds VII.1, VII.2, VII.3 and VII.4

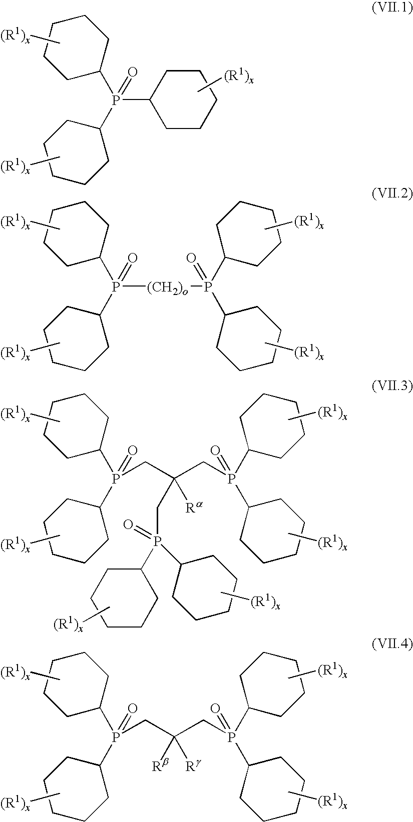

in which R¹, R^{α}, R^{β}, R^{γ}, x and o are each as defined above.

Accordingly, particularly preferred compounds IX are selected from compounds IX.1, IX.2, IX.3 and IX.4

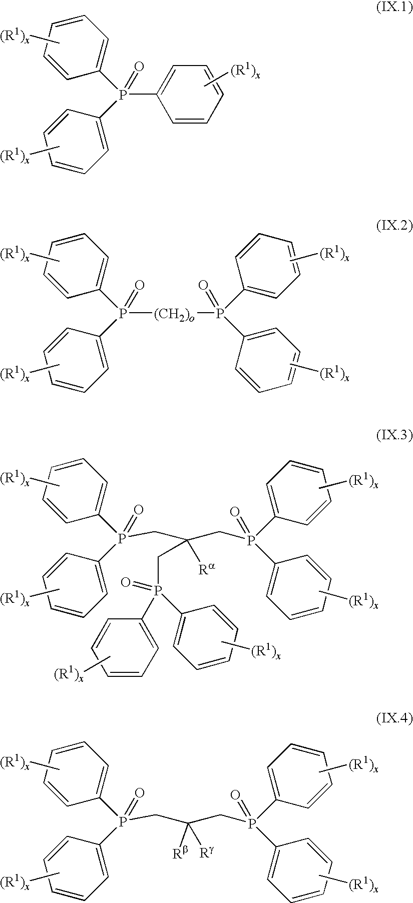

in which R¹, R^{α}, R^{β}, R^{γ}, x and o are each as defined above.

In compounds I.4, V.4, VII.4 and IX.4, R^{β} is preferably H and R^{γ} is methyl or ethyl, or R^{β} is preferably methyl and R^{γ} is methyl or ethyl.

More preferred compounds I are compounds of the formula I.1. Correspondingly, more preferred compounds V are those of the formula V.1, more preferred compounds VII are those of the formula VII.1 and more preferred compounds IX are those of the formula IX.1.

In the abovementioned compounds I.1 to I.3, V.1 to V.3, VII.1 to VII.3 and IX.1 to IX.3, x is preferably 0.

Accordingly, an even more preferred compound I is tricyclohexylphosphine, i.e. the processes A and B according to the invention serve especially to prepare tricyclohexylphosphine. Accordingly, the compound V used is especially a tricyclohexylphosphine dihalide, especially tricyclohexylphosphine dichloride, the compound VII used is especially tricyclohexylphosphine oxide and the compound IX used (also in process C) is especially triphenylphosphine oxide.

The processes according to the invention allow the preparation of compounds I, such as tricyclohexylphosphine, or of hydrohalides thereof in a high yield in few reaction steps and using simple and inexpensive reactants. In the case of preparation of tricyclohexylphosphine, they allow it to proceed from triphenylphosphine oxide, a by-product which occurs in large amounts in the Wittig reaction in the synthesis of vitamin A and of carotenoids.

The invention will now be illustrated in detail by the nonlimiting examples which follow.

### EXAMPLES

### 1. Hydrogenation of Triphenylphosphine Oxide

A mixture of triphenylphosphine oxide (707 g, 2.54 mol) and a suspension of ruthenium(IV) oxide hydrate (supported on aluminum oxide) (140 g, comprises 3 g of ruthenium) in tetrahydrofuran (2 l) was hydrogenated at from 120 to 150° C. and a hydrogen pressure of 250 bar with stirring. After cooling to room temperature, the catalyst was filtered off and the filtrate was freed of the solvent under reduced pressure. Distillation of the residue at from 200 to 210° C. (1 mbar) afforded 722 g (96% of theory) of tricyclohexylphosphine oxide in the form of a white solid.

### 2. Conversion of Tricyclohexylphosphine Oxide to Tricyclohexylphosphine Hydrochloride and Tricyclohexylphosphine

The apparatus used was a 250 ml flask with Teflon paddle stirrer, thermometer, unimmersed gas introduction tube with rotameter and excess pressure release valve (0.1 bar), a reflux cooler with cryostat and downstream dry ice cooler and an NaOH scrubbing tower. The reflux condenser was cooled to −15° C. The flask was initially charged with 8.0 g (0.027 mol) of tricyclohexylphosphine oxide in 60 ml of anhydrous toluene at room temperature, and the phosgene introduction was commenced. The initially clear colorless solution became cloudy immediately and an exothermic reaction set in, which could be controlled by throttling the phosgene introduction such that the temperature of the reaction mixture did not exceed 38° C. In addition, gas evolution set in. The phosgene introduction was continued until the gas evolution had ended (11.1 g; 0.112 mol of phosgene). Subsequently, the reaction mixture was stirred for another 30 minutes, while the temperature fell to 25° C. To remove excess phosgene, the mixture was heated to 40° C. with introduction of nitrogen for 240 minutes, and then further nitrogen was introduced at room temperature overnight for complete removal of phosgene. After adding 50 ml of toluene and stirring for 30 minutes, the flask contents (130 g) were transferred to a miniautoclave in a glove box under argon, and the autoclave was purged twice with 150 bar of nitrogen and then twice with 150 bar of hydrogen. The reaction mixture was heated to 160° C. with stirring and 100 bar of hydrogen were injected. After 48 hours, within which the pressure fell to 97 bar, the mixture was cooled and decompressed. The white flaky precipitate formed was filtered off under argon and washed twice with 10 ml of toluene each time. After the solvent had been removed under reduced pressure, 7.4 g (86% of theory) of tricyclohexylphosphine hydrochloride were obtained as a white solid.

³¹P NMR (1H-coupled) (145 MHz; toluene-d₈): δ=28.00 (d, J_{P-H}=440 Hz).

Elemental analysis (dihydrochloride): C₁₈H₃₅Cl₂P

Calculated: C, 60.8; H, 10.5; P, 8.7.

Found: C, 61.1; H, 10.2; P, 8.4.

To convert the tricyclohexylphosphine hydrochloride to the free base, a portion of the hydrochloride was admixed with 40% aqueous sodium hydroxide and the free base formed was extracted from the aqueous phase with toluene. The yield of free tricyclohexylphosphine was >90% of theory based on the amount of hydrochloride used.

Another portion of the hydrochloride was suspended in toluene for conversion to the free base, and the suspension was heated to reflux over 40 hours. The solvent was removed by distillation and the residue was distilled under reduced pressure. The yield of free tricyclohexylphosphine was >90% of theory, based on the amount of hydrochloride used.

1. A process for preparing compounds of formula I 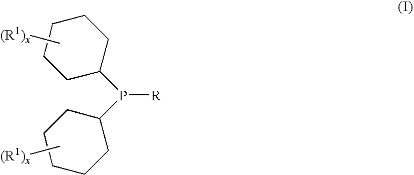
in which
R is a radical of formula II 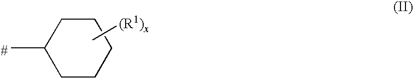
or a linear or branched alkyl radical which has from 1 to 8 carbon atoms and bears 1, 2, 3 or 4 radicals of formula III 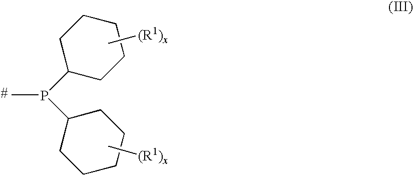
and may also bear from 1 to 4 substituents of formula IV
X—(CH₂)ₐ_{b}—YR⁷ (IV)
X and Y are each independently O or NR⁸;
each R¹ is independently C₁-C₄-alkyl, C₁-C₄-haloalkyl, C₁-C₄-hydroxyalkyl, C₃-C₁₀-cycloalkyl, C₃-C₁₀-halocycloalkyl, halogen, OR² or COR³;
R² is H or C₁-C₄-alkyl;
R³ is H, OR⁴ or NR⁵R⁶;
R⁴, R⁵ and R⁶ are each independently H or C₁-C₄-alkyl;
R⁷ is H, C₁-C₄-alkyl or C₂-C₄-hydroxyalkyl;
or, in the case that two substituents of formula IV are bonded to the same carbon atom or to two adjacent carbon atoms of the alkyl radical, two R⁷ radicals may also together form a linear or branched alkylene group having from 1 to 6 carbon atoms;
R⁸ is H, C₁-C₄-alkyl or C₂-C₄-hydroxyalkyl;
each x is independently 0 or an integer from 1 to 3;
a is 2, 3 or 4;
b is 0 or an integer from 1 to 10; and
# denotes the point of attachment to the rest of the molecule;
or hydrohalides thereof, comprising the following:
reacting compounds of formula V 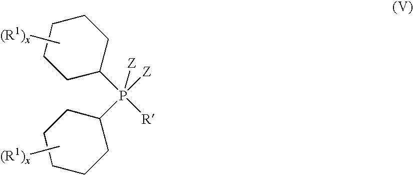
in which
R′ is a radical of formula II or a linear or branched alkyl radical which has from 1 to 8 carbon atoms and bears 1, 2, 3 or 4 radicals of formula VI 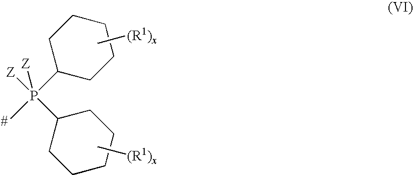
and may also bear from 1 to 4 substituents of formula IV; and
Z is halogen;
with hydrogen at a pressure of from 10 to 300 bar.

2. The process according to claim 1, wherein the pressure is from 50 to 200 bar.

3. The process according to claim 1, wherein the reaction is effected in the presence of a base.

4. The process according to claim 3, wherein the base comprises at least one amine of formula NR^{a}R^{b}R^{c} in which R^{a}, R^{b} and R^{c} are each independently H, C₁-C₁₀-alkyl, C₁-C₁₀-hydroxyalkyl, C₃-C₁₀-cycloalkyl, aryl or aryl-C₁-C₄-alkyl.

5. The process according to claim 1, further comprising neutralizing with a base or treated thermally the reaction product of the compound of formula V with hydrogen.

6. The process according to claim 1, wherein the compound of formula V is obtained by a process comprising reacting a compound of formula VII 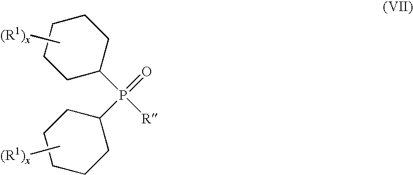
in which
R″ is a radical of formula II or a linear or branched alkyl radical which has from 1 to 8 carbon atoms and bears 1, 2, 3 or 4 radicals of formula VIII 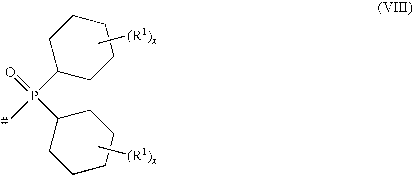
and may also bear from 1 to 4 substituents of formula IV; and
R¹, x and # are each as defined in claim 1;
with a halogenating agent.

7. The process according to claim 6, wherein the halogenating agent is at least one selected from the group consisting of phosgene, phosphorus trichloride, thionyl chloride and oxalyl chloride.

8. A process for preparing compounds of formula I as defined in claim 1 or hydrohalides thereof, comprising the following:
(a) hydrogenating compounds of formula IX 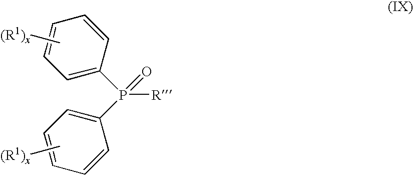
in which
R′″ is a radical of formula X 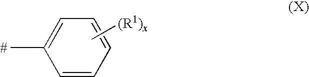
or a linear or branched alkyl radical which has from 1 to 8 carbon atoms and bears 1, 2, 3 or 4 radicals of formula XI 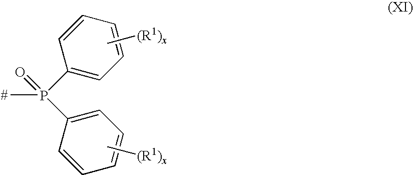
and may also bear from 1 to 4 substituents of formula IV; and
R¹, x and # are each as defined in claim 1;
to obtain compounds of formula VII as defined in claim 6;
(b) reacting the compounds of formula VII obtained in (a) with a halogenating agent to obtain compounds of formula V;
(c) reacting the compounds of formula V obtained in (b) with a reducing agent to obtain compounds I or a hydrohalide thereof.

9. The process according to claim 8, wherein the hydrogenation in (a) comprises the reaction of compounds IX with hydrogen in the presence of a hydrogenation catalyst.

10. The process according to claim 9, wherein the hydrogenation catalyst comprises at least one metal of group VIII.

11. The process according to claim 10, wherein the metal of group VIII is at least one selected from the group consisting of ruthenium, cobalt, rhodium, nickel, palladium and platinum.

12. The process according to claim 11, wherein the metal of group VIII is ruthenium.

13. The process according to claim 12, wherein the ruthenium-based hydrogenation catalyst is at least one selected from the group consisting of ruthenium(IV) oxide, the hydrate thereof, ruthenium(VIII) oxide, the hydrate thereof, elemental ruthenium and elemental ruthenium in a mixture with at least one metal of groups VIIb, VIII, Ib or IIb.

14. The process according to claim 8, wherein the halogenating agent in (b) is at least one selected from the group consisting of phosgene, phosphorus trichloride, thionyl chloride and oxalyl chloride.

15. The process according to claim 8, wherein the reducing agent in (c) is at least one selected from the group consisting of hydrogen, metals of the first to fifth main group, transition group elements which are selected from the group consisting of Sc, Y, La, Ti, Zr, Hf, V, Nb, Ta, Cr, Mo, W, Mn, Tc, Re, Fe, Co, Ni and Zn, boron, silicon, arsenic, selenium, tellurium, lithium aluminum hydride, phosphorus and carbon.

16. The process according to claim 15, wherein the reducing agent in (c) is at least one selected from the group consisting of hydrogen, sodium, potassium, magnesium, aluminum, iron, lithium aluminum hydride and silicon.

17. The process according to claim 16, wherein the reduction in (c) is effected by reacting the compounds V with hydrogen as a reducing agent at a pressure of from 10 to 300 bar.

18. A process for preparing compounds of formula VII as defined in claim 6, comprising the following:
reacting compounds of formula IX 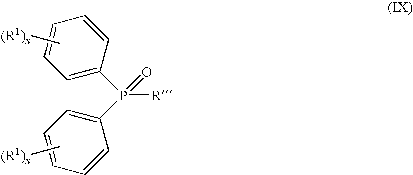
with hydrogen in the presence of a ruthenium-based hydrogenation catalyst.

19. The process according to claim 18, wherein the ruthenium-based hydrogenation catalyst is at least one selected from the group consisting of ruthenium(IV) oxide, the hydrate thereof, ruthenium(VIII) oxide, the hydrate thereof, elemental ruthenium and elemental ruthenium in a mixture with a least one metal of groups VIIb, VIII, Ib or IIb, the hydrogenation catalyst being supported on aluminum oxide.

20. The process according to claim 18, wherein the reaction is effected at a pressure of from 50 to 350 bar.

21. The process according to claim 18, wherein the reaction is effected at a temperature of from 80 to 200° C.

22. The process according to claim 1, wherein R, R′ and R″ are each a radical of formula II and R′″ is a radical of formula X.

23. The process according to claim 1, wherein
R is a radical of formula XII 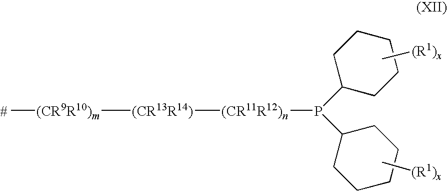
R′ is a radical of formula XIV 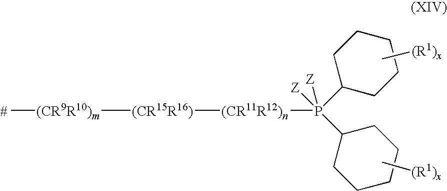
R″ is a radical of formula XVI 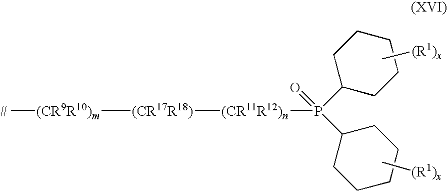
R′″ is a radical of formula XVIII 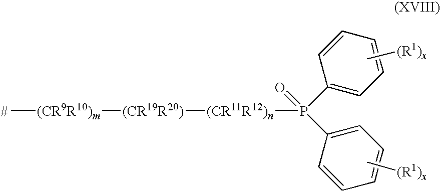
in which
R⁹, R¹⁰, R¹¹ and R¹² are each independently H, methyl or ethyl,
m and n are each independently 0, 1, 2 or 3;
R¹³ and R¹⁴ are each independently H, methyl, ethyl, —CH₂—O—R⁷, in which R⁷ is H, C₁-C₄-alkyl or C₂-C₄-hydroxyalkyl;
or, in the case that two substituents of formula IV are bonded to the same carbon atom or to two adjacent carbon atoms of the alkyl radical, two R⁷ radicals may also together form a linear or branched alkylene group having from 1 to 6 carbon atoms; or a radical of formula XIII 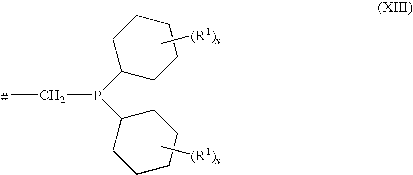
R¹⁵ and R¹⁶ are each independently H, methyl, ethyl, —CH₂—O—R⁷, in which R⁷ is H, C₁-C₄-alkyl or C₁-C₄-hydroxyalkyl;
or, in the case that two substituents of formula IV are bonded to the same carbon atom or to two adjacent carbon atoms of the alkyl radical, two R⁷ radicals may also together form a linear or branched alkylene group having from 1 to 6 carbon atoms; or a radical of formula XV 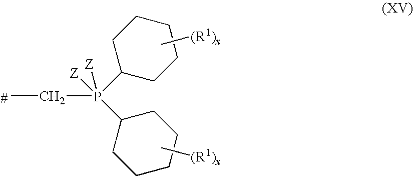
R¹⁷ and R¹⁸ are each independently H, methyl, ethyl, —CH₂—O—R⁷, in which R⁷ is H, C₁-C₄-alkyl or C₁-C₄-hydroxyalkyl;
or, in the case that two substituents of formula IV are bonded to the same carbon atom or to two adjacent carbon atoms of the alkyl radical, two R⁷ radicals may also together form a linear or branched alkylene group having from 1 to 6 carbon atoms; or a radical of formula XVII 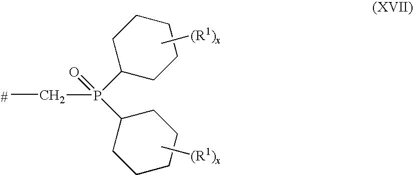
R¹⁹ and R²⁰ are each independently H, methyl, ethyl, —CH₂—O—R⁷, in which R⁷ is H, C₁-C₄-alkyl or C₇-C₄-hydroxyalkyl;
or, in the case that two substituents of formula IV are bonded to the same carbon atom or to two adjacent carbon atoms of the alkyl radical, two R⁷ radicals may also together form a linear or branched alkylene group having from 1 to 6 carbon atoms; or a radical of formula XIX 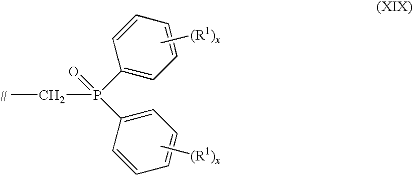
and
R¹ is C₁-C₄-alkyl, C₁-C₄-haloalkyl, C₁-Cₐ-hydroxyalkyl, C₃-C₁₀-cycloalkyl, C₃-C₁₀-halocycloalkyl, halogen, OR² or COR^{S}, Z is halogen and x is 0 or an integer from 1 to 3.

24. The process according to claim 23, wherein R⁹, R¹⁰, R¹¹, R¹², R¹³, R¹⁴, R¹⁵, R¹⁶, R¹⁷, R¹⁸, R¹⁹ and R²⁰ are each H and the sum of m and n is 0, 1, 2 or 3.

25. The process according to claim 23, wherein m is 0, n is 1, R¹¹, R¹³, R¹⁵, R¹⁷ and R¹⁹ are each H, and R¹², R¹⁴, R¹⁶, R¹⁸ and R²⁰ are each methyl or ethyl.

26. The process according to claim 23, wherein
R⁹, R¹⁰, R¹¹ and R¹² are each H;
m and n are each 1;
R¹³ is a radical of formula XIII;
R¹⁴ is H, methyl, ethyl or a radical of formula XIII;
R¹⁵ is a radical of formula XV;
R¹⁶ is H, methyl, ethyl or a radical of formula XV;
R¹⁷ is a radical of formula XVII;
R¹⁸ is H, methyl, ethyl or a radical of formula XVII;
R¹⁹ is a radical of formula XIX; and
R²⁰ is H, methyl, ethyl or a radical of formula XIX.

27. The process according to claim 23, wherein
R⁹, R¹⁰, R¹¹ and R¹² are each H;
m and n are each 1;
R¹³, R¹⁵, R¹⁷ and R¹⁹ are each H, methyl or ethyl; and
R¹⁴, R¹⁶, R¹⁸ and R²⁰ are each methyl or ethyl.

28. The process according to claim 1, wherein x is 0.
